(19) United States
(12) Patent Application Publication
(10) Pub. No.: US 2026/0329054 A1
(43) Pub. Date: Oct. 22, 2026

(54) OPTICAL SYSTEM AND CAMERA DEVICE COMPRISING SAME

(71) Applicant: LG INNOTEK CO., LTD., Seoul (KR)

(72) Inventor: Ju Yong SHIM, Seoul (KR)

(73) Assignee: LG INNOTEK CO., LTD., Seoul (KR)

(21) Appl. No.: 19/109,682

(22) PCT Filed: Sep. 8, 2023
(86) PCT No.: PCT/KR2023/013515

§ 371 Date: Mar. 7, 2025

(30) Foreign Application Priority Data
Sep. 8, 2022 (KR) 10-2022-0114294

(51) Int. Cl. G02B 9/62; G02B 13/00

(52) U.S. Cl. CPC G02B 9/62; G02B 13/0045

(57) ABSTRACT

An optical system according to an embodiment of the present invention comprises a first lens, a second lens, a third lens, a fourth lens, a fifth lens, and a sixth lens arranged sequentially from an object side to an image side, wherein the first lens has positive refractive power, the second lens has negative refractive power, the third lens has positive refractive power, the fourth lens has negative refractive power, the fifth lens has positive refractive power, and the sixth lens has negative refractive power, and the diameter of the first lens is 90 to 110% of entrance pupil diameter (EPD).

### CROSS REFERENCE TO RELATED APPLICATIONS

This application is the National Phase of PCT International Application No. PCT/KR2023/013515, filed on Sep. 8, 2023, which claims priority under 35 U.S.C. 119(a) to Patent Application No. 10-2022-0114294, filed in the Republic of Korea on Sep. 8, 2022, all of which are hereby expressly incorporated by reference into the present application.

### TECHNICAL FIELD

Embodiments of the present invention relates to an optical system and a camera device including the same.

### BACKGROUND ART

As the performance of a camera device built in a mobile terminal progresses, the demand for higher resolution in the camera device in the mobile terminal is also increasing. In order to improve the performance of the camera device, the high performance of an optical system and an image sensor is required. However, due to a narrow space in the mobile terminal, the high-performance of the optical system and the image sensor is not easy.

Specifically, the need for miniaturization of the camera device is further increasing. As the camera device becomes smaller, an amount of light which reaches the image sensor through the optical system may decrease. Accordingly, an F-number which determines the brightness of an image may increase, and an amount of light which reaches a peripheral region of the image sensor may decrease compared an amount of light which reaches a central region of the image sensor.

### DISCLOSURE

### Technical Problem

The technical problem to be achieved by the present invention is to acquiring a camera module with a small F-number, a large field of view, and a high relative illumination while being implemented in a small size.

The problem to be solved in the embodiment is not limited to this, and it can be said that the purpose or effect that can be understood from the specific contents for implementing the solution or invention of the problem described below is also included.

### Technical Solution

An optical system according to an embodiment of the present invention includes a first lens, a second lens, a third lens, a fourth lens, a fifth lens, and a sixth lens, which are sequentially disposed from an object side to an image side, wherein the first lens has positive refractive power, the second lens has negative refractive power, the third lens has positive refractive power, the fourth lens has negative refractive power, the fifth lens has positive refractive power, and the sixth lens has negative refractive power, a diameter of the first lens is 90 to 10% of an entrance pupil diameter (EPD).

An aperture may be disposed at an edge of an object-side surface of the first lens.

An image-side surface of the fifth lens may be convex toward the image side, an object-side surface of the sixth lens may be concave toward the object side, and a distance between the image-side surface of the fifth lens and the object-side surface of the sixth lens may decrease as it gets farther away from the optical axis to a certain distance from the optical axis.

An image-side surface of the fifth lens may be convex toward the image side, an object-side surface of the sixth lens may be concave toward the object side, and a maximum tilt angle on the object-side surface of the sixth lens may be larger than a maximum tilt angle on the image-side surface of the fifth lens from the optical axis to a certain distance.

A ratio of an absolute value of a radius of curvature of the object-side surface of the sixth lens to an absolute value of a radius of curvature of the image-side surface of the fifth lens may be 2 to 3.

At least one of an object-side surface of the second lens, an image-side surface of the third lens, an object-side surface of the fourth lens, an image-side surface of the fourth lens, an object-side surface of the fifth lens, and an image-side surface of the sixth lens may include a critical point.

The object-side surface of the fourth lens and the image-side surface of the fourth lens may each include a critical point.

The object-side surface of the fifth lens may include a critical point.

A vertical distance from the optical axis to the critical point of the object-side surface of the fourth lens may be 0.9 to 1.1 times a vertical distance from the optical axis to the critical point of the image-side surface of the fourth lens, and may be 0.9 to 1.1 times a vertical distance from the optical axis to the critical point of the object-side surface of the fifth lens.

The certain distance may be a vertical distance between at least one of the critical point of the object-side surface of the fourth lens, the critical point of the image-side surface of the fourth lens, and the critical point of the object-side surface of the fifth lens and the optical axis.

An F-number may be 2 or less, a field of view (FOV) may be 84 degrees or more, and a relative illumination (RI) may be 25% or more.

An optical system according to another embodiment of the present invention includes a first lens, a second lens, a third lens, a fourth lens, a fifth lens, and a sixth lens, which are disposed sequentially from an object side to an image side, wherein the first lens has positive refractive power, the second lens has negative refractive power, the third lens has positive refractive power, the fourth lens has negative refractive power, the fifth tens has positive refractive power, and the sixth lens has negative refractive power, the first lens has the smallest diameter among the first to sixth lenses, an object-side surface of the fourth lens, an image-side surface of the fourth lens, and an object-side surface of the fifth lens each includes a critical point, the image-side surface of the fifth lens is convex toward the object side, and an object-side surface of the sixth lens is concave toward the object side, and an absolute value of a radius of curvature of the image-side surface of the fifth lens is greater than an absolute value of a radius of curvature of the object-side surface of the sixth lens.

A vertical distance from the optical axis to the critical point of the object-side surface of the fourth lens may be 0.9 to 1.1 times a vertical distance from the optical axis to a critical point of an image-side surface of the fourth lens, and may be 0.9 to 1.1 times a vertical distance from the optical axis to the critical point of the object-side surface of the fifth lens.

A maximum tilt angle on the object-side surface of the sixth lens may be larger than a maximum tilt angle on the image-side surface of the fifth lens to a vertical distance between at least one of the critical point of the object-side surface of the fourth lens, the critical point of the image-side surface of the fourth lens, and the critical point of the object-side surface of the fifth lens and the optical axes.

A camera device according to an embodiment of the present invention includes an image sensor, a filter disposed on the image sensor, and an optical system disposed on the filter, wherein the optical system includes a first lens, a second lens, a third lens, a fourth lens, a fifth lens, and a sixth lens, which are sequentially disposed from an object side to an image side, the first lens has positive refractive power, the second lens has negative refractive power, the third lens has positive refractive power, the fourth lens has negative refractive power, the fifth lens has positive refractive power, and the sixth lens has negative refractive power, a diameter of the first lens is 90 to 110% of an entrance pupil diameter (EPD).

### Advantageous Effects

According to the embodiment of the present invention, a camera device with a small F-number, a large field of view (FOV), and a high relative illumination (RI) ratio can be acquired while being implemented in a compact size.

According to the embodiment of the present invention, a camera device with an F-number of 2 or less, an FOV of 84 degrees or more, and an RI in a 1 field of 25% or more while being implemented in a small size can be acquired.

According to the embodiment of the present invention, a camera device providing a bright image with a high RI while minimizing a head size exposed to the outside can be acquired. That is, in order to minimize the head size exposed to the outside, a camera device providing a bright image with a high RI at a periphery of a sensor while designing a diameter of a first lens, that is, a lens disposed closest to an object side, to be small can be acquired.

### DESCRIPTION OF DRAWINGS

FIG. 1 shows an optical system according to an embodiment of the present invention.

FIG. 2 shows a relationship between a first lens and an aperture in the optical system according to the embodiment of the present invention.

FIGS. 3 and 4 are views for describing a relative illumination.

FIG. 5 is design data showing distances between lens surfaces according to a distance in a Y direction from an optical axis in the optical system according to the embodiment of the present invention.

FIG. 6 is design data showing sag values of lens surfaces according to a distance in the Y direction from the optical axis in the optical system according to the embodiment of the present invention.

FIG. 7 is design data showing tilt angles of lens surfaces according to a distance in the Y direction from the optical axis in the optical system according to the embodiment of the present invention.

FIG. 8 shows a modulation transfer function (MTF) using the optical system according to one embodiment of the present invention.

FIG. 9 shows a distortion grid using the optical system according to one embodiment of the present invention.

FIG. 10 is a view showing a portion of a mobile terminal to which a camera device according to one embodiment of the present invention is applied.

### MODES OF THE INVENTION

Hereinafter, exemplary embodiments according to the present invention will be described in detail with reference to the accompanying drawings.

However, the technical spirit of the present invention is not limited to some embodiments to be described, but may be implemented in various different forms, and one or more of the components between the embodiments may be selectively combined and substituted within the technical spirit of the present invention.

Further, terms (including technical and scientific terms) used in the embodiments of the present invention may be interpreted as meanings which may be generally understood by those skilled in the art unless explicitly specifically defined and described, and the meanings of the generally used terms such as terms defined in a dictionary may be understood in consideration of contextual meanings in the related art.

In addition, the terms used in the embodiments of the present invention are provided not to limit the present invention but to describe the embodiments.

In the present specification, a singular form may also include a plural form unless otherwise specified in the phrase, and may include one or more of all possible combinations of A, B, and C when disclosed as at least one (or one or more) of “A, B, and C”.

Further, terms such as first, second, A, B, (a), (b), and the like may be used to describe the components of the embodiment of the present invention.

These terms are only provided to distinguish one component from another component, and the essence, sequence, order, or the like of the elements are not limited by these terms.

Further, when a specific component is disclosed as being “connected,” “coupled,” or “linked” to another component, this may not only include a case of the component being directly connected, coupled, or linked to the other component but also a case of the component being connected, coupled, or linked to the other component by another component between the element and the other component.

In addition, when one component is disclosed as being formed “on or under” another component, the term “on or under” includes both a case in which the two components are in direct contact with each other and a case in which at least another component is disposed between the two components (indirectly). In addition, when the term “on or under” is expressed, a meaning of not only an upward direction but also a downward direction may be included based on one component.

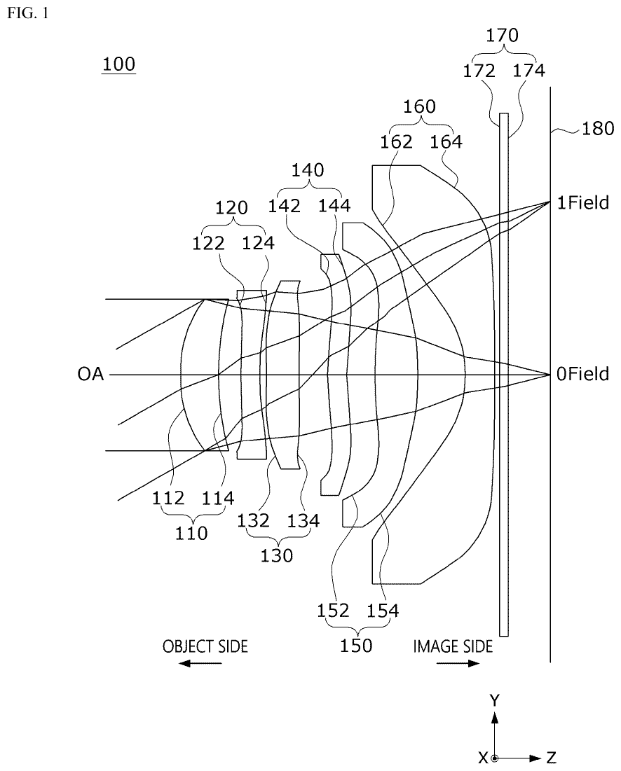

FIG. 1 shows an optical system according to an embodiment of the present invention.

Referring to FIG. 1, an optical system 100 according to the embodiment of the present invention includes a first lens 110, a second lens 120, a third lens 130, a fourth lens 140, a fifth lens 150, and a sixth lens 160, which are sequentially disposed from an object side to an image side.

Although not shown, a right-angled prism may be further disposed in front of the first lens 110.

At least one of the first lens 110, the second lens 120, the third lens 130, the fourth lens 140, the fifth lens 150, and the sixth lens 160 may include an effective region and an ineffective region. The effective region may be a region through which light incident on the lens passes, that is, a region through which the incident light is refracted to implement optical characteristics. In the present specification, an effective diameter may mean a diameter of the effective region through which effective light is incident on each surface of each lens. In the present specification, a numerical value of the effective diameter may have a certain error range. For example, a range of ±0.4 mm may be considered as the effective region for the numerical value of the effective diameter presented in the present specification. The range of ±0.4 mm may be interpreted as the effective diameter for the numerical value of the effective diameter presented in the present specification. The non-effective region is disposed at a perimeter of the effective region and may be a region where light is not incident, that is, a region unrelated to optical characteristics. The non-effective region may be a region fixed to a barrel which accommodates a lens, or the like.

According to the embodiment of the present invention, a filter 170 and an image sensor 180 may be sequentially disposed behind the sixth lens 160. In this case, the filter 170 may be an infrared (IR) filter. Accordingly, the filter 170 may block near-infrared rays, for example, light with a wavelength of 700 nm to 1100 nm, from light incident on a camera module. Alternatively, the filter 170 may be a filter which transmits IR rather than a filter which blocks IR. Further, the image sensor 180 may be connected to a printed circuit board.

Referring to FIG. 1, the optical system 100 according to the embodiment of the present invention includes the first lens 110, the second lens 120, the third lens 130, the fourth lens 140, the fifth lens 150, and the sixth lens 160, which are sequentially disposed from the object side to the image side. The first lens 110, the second lens 120, the third lens 130, the fourth lens 140, the fifth lens 150, and the sixth lens 160 may be sequentially disposed along an optical axis. The first lens 110, the second lens 120, the third lens 130, the fourth lens 140, the fifth lens 150, and the sixth lens 160 may be aspherical lenses. The first lens 110, the second lens 120, the third lens 130, the fourth lens 140, the fifth lens 150, and the sixth lens 160 may each be made of plastic or glass.

The first lens 110 has positive refractive power and includes an object-side surface 112 and an image-side surface 114, and the object-side surface 112 of the first lens 110 may be convex toward the object side and the image-side surface 114 may be concave toward the image side. Here, a case in which the surface of the lens is convex may mean that the surface of the lens in the region corresponding to the optical axis has a convex shape, and a case in which the surface of the lens is concave may mean that the surface of the lens in the region corresponding to the optical axis has a concave shape. Here, the region corresponding to the optical axis may mean an optical axis region or a paraxial region. Furthermore, the case in which the surface of the lens is convex toward the object side may mean that the surface of the lens is concave toward the image side, and the case in which the surface of the lens is convex toward the image side may mean that the surface of the lens is concave toward the object side.

The second lens 120 has negative refractive power and includes an object-side surface 122 and an image-side surface 124, and the object-side surface 122 of the second lens 120 may be convex toward the object side and the image-side surface 124 may be concave toward the image side.

The third lens 130 has positive refractive power and includes an object-side surface 132 and an image-side surface 134, and the object-side surface 132 of the third lens 130 may be convex toward the object side and the image-side surface 134 may be convex toward the image side.

The fourth lens 140 has negative refractive power and includes an object-side surface 142 and an linage-side surface 144, and the object-side surface 142 of the fourth lens 140 may be convex toward the object side and the image-side surface 144 may be concave toward the image side.

The fifth lens 150 may have positive refractive power and include an object-side surface 152 and an image-side surface 154, and the object-side surface 152 of the fifth lens 150 is convex toward the object side and the image-side surface 154 is convex toward the image side.

The sixth lens 160 has negative refractive power and includes an object-side surface 162 and an image-side surface 164, and the object-side surface 162 of the sixth lens 160 may be concave toward the object side and the image-side surface 164 may be concave toward the image side.

In the embodiment of the present invention, when the first lens 110 has positive refractive power, the second lens 120 has negative refractive power, the third lens 130 has positive refractive power, the fourth lens 140 has negative refractive power, the fifth lens 150 has positive refractive power, and the sixth lens 160 has negative refractive power, chromatic aberration may be corrected.

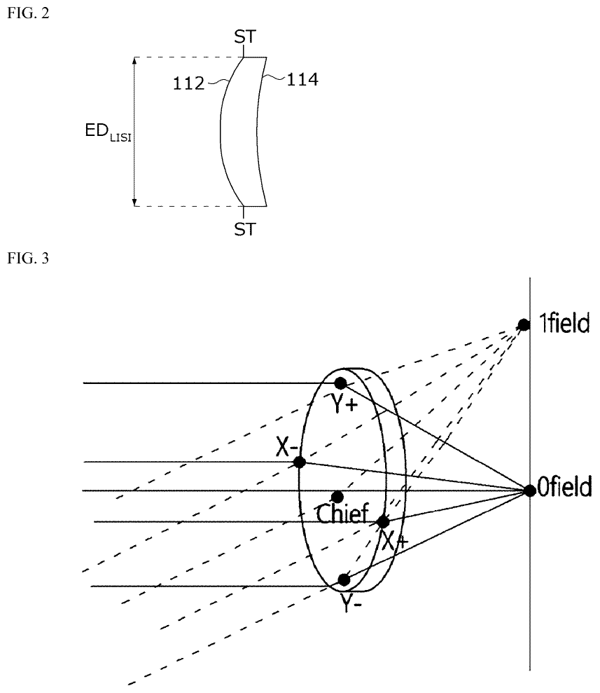

FIG. 2 shows a relationship between a first lens and an aperture in the optical system according to the embodiment of the present invention.

Referring to FIG. 2, an aperture ST is disposed on the first lens 110. The aperture ST may adjust an amount of light incident on the optical system 100. For example, the aperture ST may be disposed at an edge of the object-side surface 112 of the first lens 110. For example, the aperture ST may be disposed to be in contact with the edge of the object-side surface 112 of the first lens 110. Accordingly, an effective diameter (ED_{L1S1}) of the first lens 110 may be 90% to 110%, preferably 95% to 110%, more preferably 97% to 110%, and more preferably 100% to 110% of an entrance pupil diameter (EPD) of the optical system 100.

Accordingly, since an area of the object-side surface 112 of the first lens 110 exposed to the outside may be minimized, a head size of the optical system 100 may be minimized. In addition, light may also be incident on the edge of the object-side surface 112 of the first lens 110. The entire first lens 110 may be an effective region.

Referring to FIG. 1 again, the object-side surface 112 or the image-side surface 114 of the first lens 110 has the smallest effective diameter among the first to sixth lenses 110, . . . , and 160. For example, the effective diameter (ED_{LIS1}) of the object-side surface 112 of the first lens 110 may be 1.62 mm to 1.98 mm, and preferably 1.7 mm to 1.9 mm. According to the embodiment of the present invention, the effective diameter of the object-side surface 112 of the first lens 110 may be smaller than a length in a diagonal direction of the image sensor 180. For example, the effective diameter of the object-side surface 112 of the first lens 110 may be 70% or less, preferably 50% or less, more preferably 40% or less, and more preferably 30% or less of the length in the diagonal direction of the image sensor 170. Accordingly, the head size of the optical system 100 may be reduced while manufacturing of the first lens 110 is possible. As shown in FIG. 2, since the aperture ST is disposed at the edge of the object-side surface 112 of the first lens 110, the EPD of the optical system 100 according to the embodiment of the present invention may be 1.62 mm to 1.98 mm, and preferably 1.7 mm to 1.9 mm. When the aperture ST is disposed at the edge of the object-side surface 112 of the first lens 110, since the amount of light incident on the first lens 110 may be maximized while minimizing the area of the optical system 100 exposed to the outside, the optical system 100 may be implemented in a compact size. For example, a camera device including the optical system 100 according to the embodiment of the present invention may be implemented so as not to be exposed to the user's naked eye. For example, the camera device including the optical system 100 according to the embodiment of the present invention may be implemented to be disposed on the front of a mobile terminal. For example, the camera device including the optical system 100 according to the embodiment of the present invention may be implemented to be disposed under a display.

Meanwhile, as the effective diameter of the first lens 110 becomes smaller, the head size exposed to the outside may be minimized. However, as the effective diameter of the first lens 110 becomes smaller, the amount of light incident on the optical system 100 may be insufficient. Accordingly, when the optical system including the first lens 110 is designed, it is necessary to consider conditions for brightening the image by reducing an F number and improving a ratio of an amount of light incident on the periphery of the image sensor to an amount of light incident on a central portion of the image sensor, that is, a relative Illumination (RI).

Here, the central portion of the image sensor means a region close to a 0 field of the image sensor, and the periphery of the image sensor means a region close to a 1 field of the image sensor.

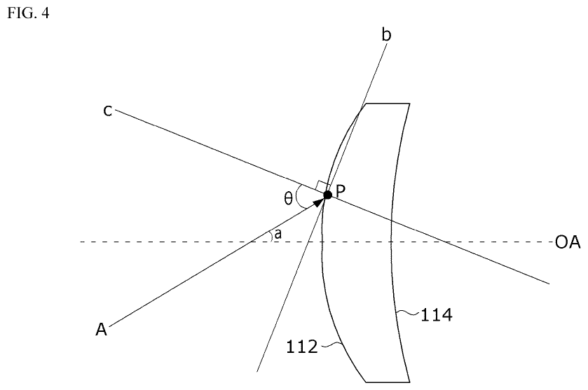

FIGS. 3 and 4 are views for describing the relative illumination.

Referring to FIG. 3, it can be seen that a region which reaches the image sensor varies depending on an incident angle of light incident from the object side. That is, the image sensor is divided into a 0 field region which is the central portion of the image sensor, and a 1 field region which is the farthest position from the central portion of the image sensor, and it can be seen that light reaches closer to the 1 field region (the periphery) of the image sensor as the incident angle of the light is larger, and the light reaches closer to the 0 field region (the central portion) as the incident angle of the light is smaller.

Referring to FIG. 4, it is assumed that a first ray A is a ray parallel to a field of view (FOV) of the optical system 100. The first ray A may be incident on the object-side surface 112 of the first lens 110 to have an angle of a with respect to an optical axis OA of the first lens 110. In this case, an angle formed by the first ray A and a normal line (line c) at a point P where the first ray A and the object-side surface 112 of the first lens 110 contact each other may be defined as an incident angle θ.

According to the embodiment of the present invention, the lenses forming the optical system 100 are designed to reduce the F-number and improve the RI.

Tables 1 and 2 below show the optical characteristics of the lenses included in the optical system according to the embodiment of the present invention, and Tables 3 and 4 show aspheric coefficients of lenses included in the optical system according to the embodiment of the present invention.

TABLE 1

| | Lens | | | Radius of | | | Effective |
|---|---|---|---|---|---|---|---|
| Lens | Surface | | Critical | curvature | Curvature | Thickness | Diameter |
| Number | Number | Shape | Point | (R, mm) | (C, mm) | (mm) | (mm) |
| First | 112 | Convex | Not | 1.579 | 0.6332 | 0.446 | 1.800 |
| Lens | | | Present | | | | |
| | 114 | Concave | Not | 3.379 | 0.2959 | 0.262 | 1.795 |
| | | | Present | | | | |
| Second | 122 | Convex | Present | 6.653 | 0.1503 | 0.230 | 1.823 |
| Lens | 124 | Concave | Not | 3.531 | 0.2832 | 0.057 | 2.007 |
| | | | Present | | | | |
| Third | 132 | Convex | Not | 5.140 | 0.1945 | 0.406 | 2.197 |
| Lens | | | Present | | | | |
| | 134 | Convex | Present | −26.137 | −0.0383 | 0.327 | 2.206 |
| Fourth | 142 | Convex | Present | 2.831 | 0.3532 | 0.230 | 2.508 |
| Lens | 144 | Concave | Present | 2.618 | 0.3819 | 0.321 | 2.855 |
| Fifth | 152 | Convex | Present | 3.921 | 0.2551 | 0.511 | 2.965 |
| Lens | 154 | Convex | Not | −2.941 | −0.3400 | 0.558 | 3.584 |
| | | | Present | | | | |
| Sixth | 162 | Concave | Not | −1.233 | | 0.350 | 3.855 |
| Lens | | | Present | | | | |
| | 164 | Concave | Present | 29.247 | | 0.053 | 4.921 |
| Filter | 172 | | | | | 0.110 | |
| | 174 | | | | | 0.490 | |
| Sensor | 180 | | | | | | |

TABLE 2

| | Lens | Focal | | | | Edge |
|---|---|---|---|---|---|---|
| Lens | Surface | Length | | Abbe | Refractive | Thickness |
| Number | Number | (f, mm) | Power | Number | Index | (mm) |
| First | 112 | 5.0806 | 0.20 | 55.7074 | 1.5371 | 0.2611 |
| Lens | 114 | | | | | |
| Second | 122 | −11.2443 | −0.09 | 18.1193 | 1.6898 | 0.3316 |
| Lens | 124 | | | | | |
| Third | 132 | 8.0339 | 0.12 | 55.7074 | 1.5371 | 0.2297 |
| Lens | 134 | | | | | |
| Fourth | 142 | −96.0426 | −0.01 | 25.9602 | 1.6206 | 0.2046 |
| Lens | 144 | | | | | |
| Fifth | 152 | 3.2124 | 0.31 | 55.7074 | 1.5371 | 0.2299 |
| Lens | 154 | | | | | |
| Sixth | 162 | −2.1937 | −0.46 | 55.7074 | 1.5371 | 0.5607 |
| Lens | 164 | | | | | |
| Filter | 172 | | | | | |
| | 174 | | | | | |
| Sensor | 180 | | | | | |

TABLE 3

| | First Lens | | Second Lens | | Third Lens | |
|---|---|---|---|---|---|---|
| | Lens Surface Number | | | | | |
| | 112 | 114 | 122 | 124 | 132 | 134 |
| Conic | −0.024 | −1.943 | 41.160 | −7.060 | −1.648 | 84.468 |
| Constant | | | | | | |
| 4th order | 2.83E−03 | −4.95E−03 | −1.48E−01 | −6.76E−02 | 2.72E−02 | −3.39E−02 |
| 6th order | 1.21E−02 | 3.73E−03 | −1.92E−02 | −5.99E−03 | −1.40E−02 | 1.96E−02 |
| 8th order | −1.98E−03 | −1.24E−02 | 2.69E−03 | 9.45E−03 | 8.13E−03 | 1.63E−03 |
| 10th order | 2.55E−03 | 1.04E−02 | 9.65E−04 | 7.66E−03 | 1.90E−03 | −4.39E−03 |
| 12th order | 6.14E−03 | 9.59E−03 | −1.44E−02 | 1.64E−03 | 3.15E−03 | 1.01E−03 |
| 14th order | 5.61E−03 | −4.53E−03 | −2.00E−02 | −6.21E−03 | 4.04E−03 | 2.44E−03 |
| 16th order | −2.43E−03 | −2.69E−02 | −1.35E−02 | −8.34E−03 | 2.97E−03 | 2.17E−03 |
| 18th order | −9.65E−03 | −3.14E−02 | −2.76E−03 | −4.21E−03 | 5.21E−04 | 1.82E−03 |
| 20th order | 6.88E−03 | 2.92E−02 | −6.95E−03 | 8.87E−03 | −2.34E−03 | 2.19E−03 |

TABLE 4

| | Fourth Lens | | Fifth Lens | | Sixth Lens | |
|---|---|---|---|---|---|---|
| | Lens Surface Number | | | | | |
| | 142 | 144 | 152 | 154 | 162 | 164 |
| Conic | −27.561 | −26.935 | −48.635 | 0.569 | −0.790 | −71.528 |
| Constant | | | | | | |
| 4th order | −7.07E−02 | −9.98E−02 | −1.13E−02 | 3.18E−02 | 1.18E−02 | −2.41E−02 |
| 6th order | 6.35E−03 | 5.60E−03 | −3.38E−02 | 7.23E−03 | 1.28E−02 | 4.71E−03 |
| 8th order | 1.93E−04 | 1.45E−03 | −7.64E−03 | −5.62E−03 | 1.51E−03 | −1.24E−03 |
| 10th order | −3.64E−03 | 1.62E−03 | 4.48E−03 | −5.61E−04 | −6.00E−04 | 6.15E−05 |
| 12th order | −2.12E−03 | 3.31E−04 | −6.24E−04 | 1.01E−04 | −6.70E−05 | −6.32E−06 |
| 14th order | 6.38E−05 | 3.08E−05 | −1.04E−03 | 5.27E−05 | 8.38E−07 | −2.27E−07 |
| 16th order | 4.32E−04 | −2.40E−05 | 4.11E−05 | 9.63E−06 | 5.67E−06 | 2.75E−07 |
| 18th order | −5.11E−06 | −2.55E−05 | 2.18E−04 | 6.15E−08 | 7.37E−07 | 5.06E−08 |
| 20th order | −4.30E−04 | −1.85E−05 | −4.36E−05 | −1.53E−06 | −2.75E−07 | −9.66E−09 |

In Table 1, the thickness (mm) represents a distance from each lens surface to the next lens surface. For example, the thickness disclosed for the object-side surface 112 of the first lens 110 represents a distance from the object-side surface 112 to the image-side surface 114 of the first lens 110. Here, the thickness in Table 1 may mean a center thickness. The center thickness may mean a thickness on the optical axis. Specifically, the thickness disclosed for the object-side surface 112 of the first lens 110 may represent a distance between a center of curvature of the object-side surface 112 and a center of curvature of the image-side surface 114 of the first lens 110. For convenience of description, the thickness disclosed for the object-side surface of each lens may mean a center thickness of each lens.

The thickness disclosed for the image-side surface 114 of the first lens 110 represents a distance from the image-side surface 114 of the first lens 110 to the object-side surface 122 of the second lens 120. Specifically, the thickness disclosed for the image-side surface 114 of the first lens 110 represents a distance between a center of curvature of the image-side surface 114 of the first lens 110 and a center of curvature of the object-side surface 122 of the second lens 120. For convenience of description, the thickness disclosed for the object-side surface of each lens may mean a distance between two lenses on the optical axis disposed adjacent to each other.

In the optical system 100 according to the embodiment of the present invention, the first lens 110, the second lens 120, and the third lens 130 may be referred to as a first lens group G1, and the fourth lens 140, the fifth lens 150, and the sixth lens 160 may be referred to as a second lens group G2.

According to the embodiment of the present invention, the second lens 120 or the fourth lens 140 may have the smallest center thickness among the first to sixth lenses. The fifth lens 150 may have the largest center thickness among the first to six lenses. According to the embodiment of the present invention, the center thickness of the fifth lens 150 may be 2 times or more, and preferably 2 to 3 tines the center thickness of the fourth lens 140. Accordingly, the assembly and alignment of the first to sixth lenses are easy.

According to the embodiment of the present invention, a distance on between the second lens 120 and the third lens 130 on the optical axis may have the shortest inter-lens distance among the first to sixth lenses. According to the embodiment of the present invention, a distance between the fifth lens 150 and the sixth lens 160 on the optical axis may have the longest inter-lens distance among the first to sixth lenses. According to the embodiment of the present invention, the distance between the second lens 120 and the third lens 130 on the optical axis, a distance between the first lens 110 and the second lens 120 on the optical axis, a distance between the fourth lens 140 and the fifth lens 150 on the optical axis, a distance between the third lens 130 and the fourth lens 140 on the optical axis, and the distance between the fifth lens 150 and the sixth lens 160 on the optical axis may increase in this order. The distance between the fifth lens 150 and the sixth lens 160 on the optical axis may be 1.6 to 2.6 times, and preferably 1.9 to 2.3 times the distance between the first lens 110 and the second lens 120 on the optical axis, may be 8 to 12 times, and preferably 9 to 11 times the distance between the second lens 120 and the third lens 130 on the optical axis, may be 1.5 to 2.5 times, and preferably 1.6 to 2 times the distance between the third lens 130 and the fourth lens 140 on the optical axis, and may be 1.5 to 2.5 times, and preferably 1.6 to 2 times the distance between the fourth lens 140 and the fifth lens 150 on the optical axis.

When at least one of the power of the first to sixth lens, a shape of a lens surface, the center thickness of the lens, and the distance between the lenses satisfies the above-described condition, the first lens group G1 may serve to collect light and correct chromatic aberration, and the second lens group G2 may serve to uniformly spread light to each peripheral pixel of the image sensor. That is, according to the embodiment of the present invention, the effective diameter of the object-side surface 112 of the first lens 110 is designed to be smaller than the image sensor 180 in order to reduce the head size of the optical system 100. When the distances between the lenses in the first lens group G1 satisfies the above conditions, light may be collected without distortion even when the effective diameter of the object-side surface 112 of the first lens 110 is sufficiently small. Further, when the distances between the first lens group G1 and the second lens group G2 and the distances between the lenses in the second lens group G2 satisfy the above conditions, that is, when disposed farther than the distances between the lenses in the first lens group G1, the light collected by the first lens group G1 may pass through the second lens group G2 and uniformly reach each pixel of the image sensor 180 without distortion.

According to the embodiment of the present invention, the first lens 110, the second lens 120, and the third lens 130 have positive composite power, and the fourth lens 140, the fifth lens 150, and the sixth lens 160 have negative composite power. That is, the composite power of the first lens 110, the second lens 120, and the third lens 130 may be 0.23, and the composite power of the fourth lens 140, the fifth lens 150, and the sixth lens 160 may be −0.06. Accordingly, the first lens 110, the second lens 120, and the third lens 130 may serve to collect light incident on the object-side surface of the first lens 110, and the fourth lens 140, the fifth lens 150, and the sixth lens 160 may serve to spread light from the object-side surface 142 of the fourth lens 140 to the image-side surface 164 of the sixth lens 160 so that the light reaches each pixel of the image sensor 180.

Specifically, as in the embodiment of the present invention, when the first lens 110 has positive power, the second lens 120 has negative power, an absolute value of power P1 of the first lens 110 is 2 times or more an absolute value of power P2 of the second lens 120, and a center thickness CT1 of the first lens 110 is 1.5 times or more a center thickness CT2 of the second lens, the first lens 110 may collect light incident on the optical system 100, and the second lens 120 may correct chromatic aberration.

Further, when the distance between the fifth lens 150 and the sixth lens 160 on the optical axis included in the second lens group G2 has the longest inter-lens distance among the first to sixth lenses, and the center thickness of the fifth lens 150 included in the second lens group G2 is the largest among the first to sixth lenses, the second lens group G2 may serve to more uniformly spread light to the periphery of the image sensor.

According to the embodiment of the present invention, a total track length (TTL) which is a distance from the object-side surface 112 of the first lens 110 to the image sensor 180 is 4 mm to 4.5 mm, a distance from the object-side surface 122 of the second lens 120 to the image sensor 180 is 3.6424 mm, a distance from the object-side surface 132 of the third lens 130 to the image sensor 180 is 3.3554 mm, a distance from the object-side surface 142 of the fourth lens 140 to the image sensor 180 is 2.6227 mm, a distance from the object-side surface 152 of the fifth lens 150 to the image sensor 180 is 2.0716 mm, and a distance from the object-side surface 162 of the sixth lens 160 to the image sensor 180 is 1.0032 mm. Further, a back focal length (BFL) which is a distance from the image-side surface 164 of the sixth lens 160 to the image sensor 180 is 0.6 mm or more. A diagonal length (2*H_{imageD}) of the image sensor 180 is 6.538 mm. From the point of view of those skilled in the art, the BFL should be implemented at 0.6 mm or more in consideration of assembly performance. For example, in the case of a camera device having an autofocusing function, the BFL should be implemented at 0.7 mm or more for the assembly of the optical system and the image sensor, and when the optical system includes a circular asymmetric-shaped lens, the BFL should be implemented at 0.7 mm or more. Accordingly, the optical system 100 may be implemented in a compact size and may be built into a front side as well as a rear side of a mobile terminal.

According to the embodiment of the present invention, a maximum effective diameter of the lenses included in the first lens group G1 may be smaller than a minimum effective diameter of the lenses included in the second lens group G2. Here, the effective diameter may mean a diameter of an effective region of the object-side surface or the image-side surface on which light is incident.

The distances on the optical axis between the lenses included in the first lens group G1, for example, a distance (0.262 mm) between the image-side surface 114 of the first lens 110 and the object-side surface 122 of the second lens 120 on the optical axis and a distance (0.057 mm) between the image-side surface 124 of the second lens 120 and the object-side surface 132 of the third lens 130 on the optical axis are smaller than the distances between the first lens group G1 and the second lens group G2 on the optical axis, that is, a distance between the image-side surface 134 of the third lens 130 and the object-side surface 142 of the fourth lens 140 on the optical axis, and are smaller than distances between the lenses included in the second lens group G2 on the optical axis, for example, a distance between the image-side surface 144 of the fourth lens 140 and the object-side surface 152 of the fifth lens 150 on the optical axis and a distance between the image-side surface 154 of the fifth lens 150 and the object-side surface 162 of the sixth lens 160 on the optical axis.

In this case, the effective diameters of the fourth lens 140, the fifth lens 150, and the sixth lens 160 may gradually increase from the object side to the image side. For example, an effective diameter (ED_{L4S2}) of the image-side surface 144 of the fourth lens 140 may be larger than an effective diameter (ED_{L4S1}) of the object-side surface 142 of the fourth lens 140, an effective diameter (ED_{L5S1}) of the object-side surface 152 of the fifth lens 150 may be larger than the effective diameter (ED_{L4S2}) of the image-side surface 144 of the fourth lens 140, an effective diameter (ED_{L5S2}) of the image-side surface 154 of the fifth lens 150 may be larger than the effective diameter (ED_{L5S1}) of the object-side surface 152 of the fifth lens 150, an effective diameter (ED_{L6S1}) of the object-side surface 162 of the sixth lens 160 may be larger than the effective diameter (ED_{L5S2}) of the image-side surface 154 of the fifth lens 150, and an effective diameter (ED_{L6S2}) of the image-side surface 164 of the sixth lens 160 may be larger than the effective diameter (ED_{L6S1}) of the object-side surface 162 of the sixth lens 160.

Further, the maximum effective diameter (ED_{G1_max}) of the lenses included in the first lens group G1 may be 0.7 times or less, preferably 0.6 times or less, and more preferably 0.5 times or less the effective diameter (ED_{L6S2}) of the image-side surface 164 of the sixth lens 160.

Accordingly, the first lens group G1 serves to collect light incident on the optical system 100 to adjust an incident angle of light incident on the second lens group G2. Further, the second lens group G2 may serve to disperse light incident on the second lens group G2 after passing through the first lens group G1 to increase the amount of light which reaches the periphery of the image sensor 180.

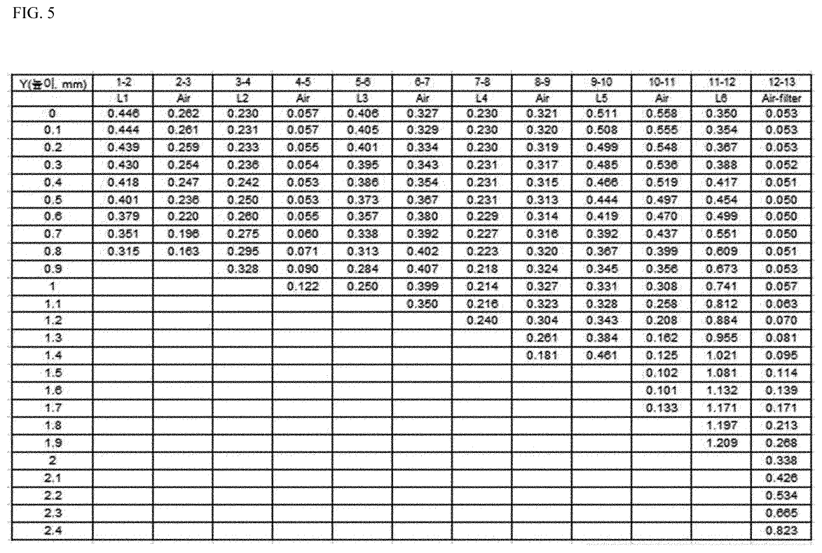

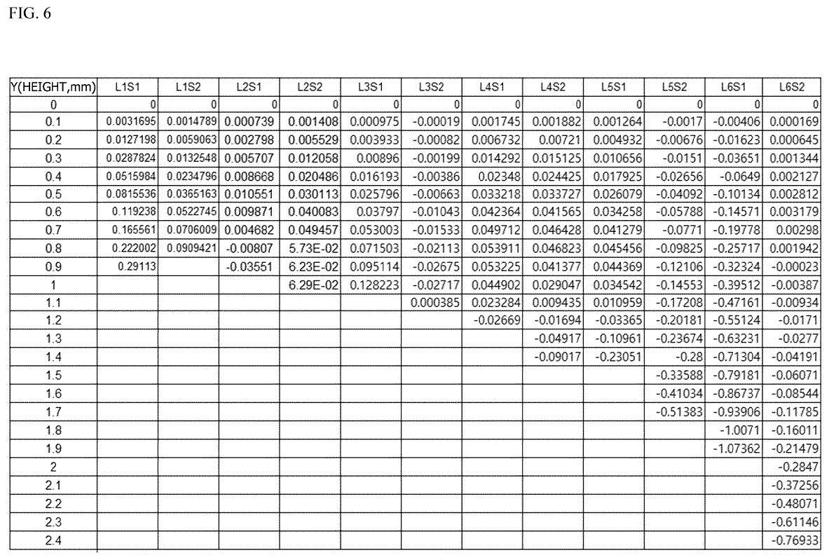

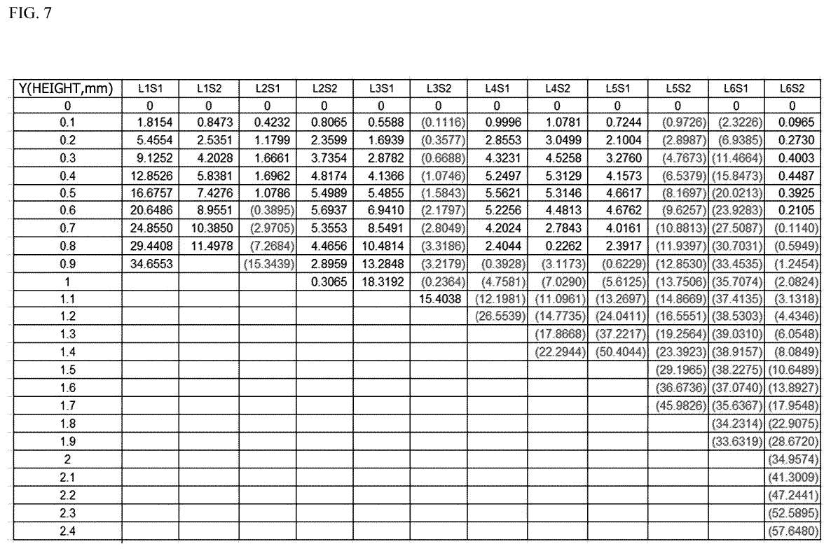

FIG. 5 is design data showing distances between lens surface according to a distance in a Y direction from an optical axis in the optical system according to the embodiment of the present invention, FIG. 6 is design data showing sag values of lens surfaces according to a distance in the Y direction from the optical axis in the optical system according to the embodiment of the present invention, and FIG. 7 is design data showing tilt angles of lens surfaces according to a distance in the Y direction from the optical axis in the optical system according to the embodiment of the present invention. In FIGS. 5 to 7, L1, L2, L3, L4, L5, and L6 respectively mean the first lens 110, the second lens 120, the third lens 130, the fourth lens 140, the fifth lens 150, and the sixth lens 160, and L1S1, L1S2, L2S1, L2S2, L3S1, L3S2, L4S1, L4S2, L5S1, L5S2, L6S1, and L6S2 respectively represent the object-side surface 112 and the image-side surface 114 of the first lens 110, the object-side surface 122 and the image-side surface 124 of the second lens 120, the object-side surface 132 and the image-side surface 134 of the third lens 130, the object-side surface 142 and the image-side surface 144 of the fourth lens 140, the object-side surface 152 and the image-side surface 154 of the fifth lens 150, and the object-side surface 162 and the image-side surface 164 of the sixth lens 160. Air between L1 and L2 represents the distance between the first lens 110 and the second lens 120, air between L2 and L3 represents the distance between the second lens 120 and the third lens 130, air between L3 and L4 represents the distance between the third lens 130 and the fourth lens 140, air between L4 and L5 represents the distance between the fourth lens 140 and the fifth lens 150, and air between L5 and L6 represents the distance between the fifth lens 150 and the sixth lens 160.

Referring to FIG. 5, the distance between the image-side surface 114 of the first lens 110 and the object-side surface 122 of the second lens 120 may be uniformly maintained from the optical axis to an end of the image-side surface 114 of the first lens 110. Here, an end of the surface of the lens may mean an end of an effective region of the surface of the lens. Here, the optical axis may mean a point where a distance in the Y direction is 0. Here, when a ratio of a maximum distance to a minimum distance between the facing surfaces of different lenses from the optical axis to the end of the surface of the lens is 3 times or less, it may be interpreted that the distance between the facing surfaces of different lenses is uniformly maintained.

That is, a ratio of a maximum distance (T12ₘₐₓ) to a minimum distance (T12ₘᵢₙ) between the image-side surface 114 of the first lens 110 and the object-side surface 122 of the second lens 120 from the optical axis to the end of the image-side surface 114 of the first lens 110 may be 3 times or less, and preferably 2 times or less.

Similarly, the distance between the image-side surface 124 of the second lens 120 and the object-side surface 132 of the third lens 130 may be uniformly maintained from the optical axis to the end of the image-side surface 124 of the second lens 120. That is, a ratio of a maximum distance (T23ₘₐₓ) to a minimum distance (T23ₘᵢₙ) between the image-side surface 124 of the second lens 120 and the object-side surface 132 of the third lens 130 from the optical axis to the end of the image-side surface 124 of the second lens 120 may be 3 times or less.

Similarly, the distance between the image-side surface 134 of the third lens 130 and the object-side surface 142 of the fourth lens 140 may be uniformly maintained from the optical axis to an end of the image-side surface 134 of the third lens 130. That is, a ratio of a maximum distance (T34ₘₐₓ) to a minimum distance (T34ₘᵢₙ) between the image-side surface 134 of the third lens 130 and the object-side surface 142 of the fourth lens 140 from the optical axis to the end of the image-side surface 134 of the third tens 130 may be 3 times or less, preferably 2 times or less, and more preferably 1.5 times or less.

Meanwhile, referring to FIGS. 6 and 7, according to the embodiment of the present invention, at least one surface of at least one of the first to sixth lenses forming the optical system 100 includes a critical point. The critical point may mean a point where the trend of the sag value changes. The sag value means a distance on the optical axis between any point on the lens surface and a point on the optical axis. The point where the trend of the sag value changes may be a point where the sag value increases and then decreases, or a point where the sag value decreases and then increases. The critical point may mean a point where the tilt angle becomes 0. The tilt angle may be defined as an angle formed by the normal to the tangent of the lens surface and the optical axis.

According to the embodiment of the present invention, at least one of the six surfaces of the first lens 110, the second lens 120, and the third lens 130 includes a critical point. According to the embodiment of the present invention, the object-side surface 122 of the second lens 120, and the image-side surface 134 of the third lens 130 include critical points. Light is more effectively refracted near the critical point. That is, light passing through a lens surface including the critical point may be more effectively refracted compared to the light passing through a lens surface not including the critical point. Thus, when at least one of the six surfaces of the first lens 110, the second lens 120, and the third lens 130 includes the critical point and when the effective diameter of the object-side surface 112 of the first lens 110 is designed to be small to minimize the head size, or even when a maximum effective diameter in the first lens group G1 is designed to be smaller than a minimum effective diameter in the second lens group G2 to minimize the head size, light incident through the effective diameter of the object-side surface 112 of the first lens 110 may be refracted in the widest possible range between the first to third lenses, light may uniformly reach the peripheral pixels of the image sensor 180, and the performance of the optical system 100 may be enhanced.

More specifically, according to the embodiment of the present invention, the critical point of the object-side surface 122 of the second lens 120 may be a point having a vertical distance of 0.5 mm to 0.6 mm from the optical axis. For example, when the optical axis is a starting point and the end of the object-side surface 122 of the second lens 120 is an end point, the critical point of the object-side surface 122 of the second lens 120 may be disposed at a position which is about 55% to 67%. Here, the end of the surface of the lens may mean the end of the effective region of the surface of the lens, and the position of the critical point may be a position set based on a direction perpendicular to the optical axis.

According to the embodiment of the present invention, the critical point of the image-side surface 134 of the third lens 130 may be a point having a distance of 1 mm to 1.1 mm from the optical axis. For example, when the optical axis is a starting point and the end of the image-side surface 134 of the third lens 130 is an end point, the critical point of the image-side surface 134 of the third lens 130 may be disposed at a position which is about 90% to 100%

Thus, when at least one of the six surfaces of the first lens 110, the second lens 120, and the third lens 130, specifically, the image-side surface 134 of the third lens 130 includes a critical point, the light output from the first lens group G1 may be uniformly dispersed. When the image-side surface 134 of the third lens 130 includes the critical point, even when the third lens 130 is tilted, since optical performance of the optical system 100 is not significantly affected, the assembly performance of the optical system 100 may be improved. Specifically, when the optical axis is a starting point and the end of the image-side surface 134 of the third lens 130 is an end point, and when the critical point of the image-side surface 134 of the third lens 130 is located at a position which is about 90% to 100%, light near an edge of the image-side surface 134 of the third lens 130 may more uniformly spread.

Further, according to the embodiment of the present invention, at least three of the six surfaces of the fourth lens 140, the fifth lens 150, and the sixth lens 160 include critical points. According to the embodiment of the present invention, the object-side surface 142 and the image-side surface 144 of the fourth lens 140, the object-side surface 152 of the fifth lens 150, and the image-side surface 164 of the sixth lens 160 may include the critical points. The light is more effectively refracted near the critical point. When the critical point is present on the periphery of the image-side surface 164 of the sixth lens 160 which is a lens surface closest to the image sensor 180, it may be easy for the light effectively refracted at the image-side surface 164 of the sixth lens 160 to uniformly reach the peripheral pixels of the image sensor 180. Specifically, when the critical point is present on the image-side surface 164 of the sixth lens 160 which is the lens surface closest to the image sensor 180, the assembly performance of the optical system 100 may be improved compared to when the critical point is present on the image-side surface or object-side surface of the first lens 110 which is a lens surface farthest from the image sensor 180. Even when the sixth lens 160 is slightly tilted during assembly, since the assembly of the first to fifth lenses of the optical system 100 is not affected and thus optical performance is not significantly affected, the assembly performance of the optical system 100 may be improved. When the critical point is present on the image-side surface or object-side surface of the first lens 110 which is the lens surface farthest from the image sensor 180 and the first lens is tilted and assembled during the assembly, since the tilt of the assembly affects the second lens and the sixth lens which are the remaining lenses, the performance of the optical system is significantly lowered.

According to the embodiment of the present invention, the image-side surface 154 of the fifth lens 150 and the object-side surface 162 of the sixth lens 160 may not include the critical points.

According to the embodiment of the present invention, both the object-side surface 142 and the image-side surface 144 of the fourth lens 140 may have the critical points. The critical point of the object-side surface 142 of the fourth lens 140 may be a point having a distance of 0.8 mm to 0.9 mm from the optical axis. For example, when the optical axis is a starting point and the end of the object-side surface 142 of the fourth lens 140 is an end point, the critical point of the object-side surface 142 of the fourth lens 140 may be disposed at a position which is about 64% to 72%. The critical point of the image-side surface 144 of the fourth lens 140 may be a point having a distance of 0.8 mm to 0.9 mm from the optical axis. For example, when the optical axis is a starting point and the end of the image-side surface 144 of the fourth lens 140 is an end point, the critical point of the image-side surface 144 of the fourth lens 140 may be disposed at a position which is about 56% to 64%. According to the embodiment of the present invention, a distance from the optical axis to the critical point of the object-side surface 142 of the fourth lens 140 may be 0.9 to 1.1 times, preferably 0.95 to 1.05 times, more preferably 0.97 to 1.3 times, and more preferably 0.99 to 1.01 times a distance from the optical axis to the critical point of the image-side surface 144 of the fourth lens 140. Here, the distance from the optical axis to the critical point may mean a distance perpendicular to the optical axis.

According to the embodiment of the present invention, the critical point of the object-side surface 152 of the fifth lens 150 may be a point having a distance of 0.8 mm to 0.9 mm from the optical axis. For example, when the optical axis is a starting point and the end of the object-side surface 152 of the fifth lens 150 is an end point, the critical point of the object-side surface 152 of the fifth lens 150 may be disposed at a position which is about 53% to 60%. According to the embodiment of the present invention, the distance from the optical axis to the critical point of the object-side surface 142 of the fourth lens 140 may be 0.9 to 1.1 times, preferably 0.95 to 1.05 times, more preferably 0.97 to 1.3 times, and more preferably 0.99 to 1.01 times a distance from the optical axis to the critical point of the object-side surface 152 of the fifth lens 150. When the critical point of the object-side surface 142 of the fourth lens 140, the critical point of the image-side surface 144 of the fourth lens 140, and the critical point of the object-side surface 152 of the fifth lens 150 satisfy the above conditions, the second lens group G2 may serve to disperse the light incident on the second lens group G2 after passing through the first lens group G1 to increase the amount of light which reaches the periphery of the image sensor 180.

According to the embodiment of the present invention, the critical point of the object-side surface 142 of the fourth lens 140, the critical point of the image-side surface 144 of the fourth lens 140, and the critical point of the object-side surface 152 of the fifth lens 150 are sequentially located, there is no critical point on the image-side surface 154 of the fifth lens 150 and the object-side surface 162 of the sixth lens 160, and there is the critical point on the image-side surface 164 of the sixth lens 160. The critical point of the image-side surface 164 of the sixth lens 160 may be a point having a distance of 0.6 mm to 0.7 mm from the optical axis. For example, when the optical axis is a starting point and the end of the image-side surface 164 of the sixth lens 160 is an end point, the critical point of the image-side surface 164 of the sixth lens 160 may be disposed at a position which is about 24% to 29%

Meanwhile, according to the embodiment of the present invention, a distance T45 between the image-side surface 144 of the fourth lens 140 and the object-side surface 152 of the fifth lens 150 may be uniformly maintained from an optical axis OA to the end of the image-side surface 144 of the fourth lens 140. That is, a ratio of a maximum distance (T45ₘₐₓ) to a minimum distance (T45ₘᵢₙ) between the image-side surface 144 of the fourth lens 140 and the object-side surface 152 of the fifth lens 150 from the optical axis to the end of the image-side surface 144 of the fourth lens 140 may be 3 times or less, and preferably 2 times or less.

On the contrary, a distance T56 between the image-side surface 154 of the fifth lens 150 and the object-side surface 162 of the sixth lens 160 may rapidly vary from the optical axis to the end of the image-side surface 154 of the fifth lens 150. According to the embodiment of the present invention, the distance T56 between the image-side surface 154 of the fifth lens 150 and the object-side surface 162 of the sixth lens 160 may decrease as it gets farther away from the optical axis to the end of the image-side surface 154 of the fifth lens 150. As described above, the end of the lens surface may mean an end of the effective diameter. According to the embodiment of the present invention, a ratio of a maximum distance (T56ₘₐₓ) to a minimum distance (T56ₘᵢₙ) between the image-side surface 154 of the fifth lens 150 and the object-side surface 162 of the sixth lens 160 may exceed 3 times, preferably may be 4 times or more, more preferably may be 5 times or more, and more preferably may be 10 times or more.

According to the embodiment of the present invention, a point having the minimum distance (T56ₘᵢₙ) between the image-side surface 154 of the fifth lens 150 and the object-side surface 162 of the sixth lens 160 may be the end of the image-side surface 154 of the fifth lens 150, that is, the end of the effective diameter of the image-side surface 154 of the fifth lens 150 or a point within a certain distance from the end of the effective diameter, here, the certain distance may be ±0.4 mm.

To this end, an aspect of a tilt angle change of the image-side surface 154 of the fifth lens 150 and an aspect of a tilt angle change of the object-side surface 162 of the sixth lens 160 may be different.

As described above, according to the embodiment of the present invention, all of the critical point of the object-side surface 142 of the fourth lens 140, the critical point of the image-side surface 144 of the fourth lens 140, and the critical point of the object-side surface 152 of the fifth lens 150 may disposed to have similar vertical distances from the optical axis. That is, the distance from the optical axis to the critical point of the object-side surface 142 of the fourth lens 140 may be 0.9 to 1.1 times, preferably 0.95 to 1.05 times, more preferably 0.97 to 1.3 times, and more preferably 0.99 to 1.01 times the distance from the optical axis to the critical point of the image-side surface 144 of the fourth lens 140, and may be 0.9 to 1.1 times, preferably 0.95 to 1.05 times, more preferably 0.97 to 1.3 times, and more preferably 0.99 to 1.01 times the distance from the optical axis to the critical point of the object-side surface 152 of the fifth lens 150.

According to the embodiment of the present invention, within a vertical distance between the optical axis and at least one of the critical point of the object-side surface 142 of the fourth lens 140, the critical point of the image-side surface 144 of the fourth lens 140, and the critical point of the object-side surface 152 of the fifth lens 150, for example, the tilt angle on the object-side surface 162 of the sixth lens 160 may vary more rapidly than the tilt angle on the image-side surface 154 of the fifth lens 150. For example, a maximum tilt angle on the object-side surface 162 of the sixth lens 160 to a point having a vertical distance between the optical axis and the critical point of the object-side surface 152 of the fifth lens 150 may be larger than a maximum tilt angle on the image-side surface 154 of the fifth lens 150. For example, when a tilt angle on the optical axis of the image-side surface 154 of the fifth lens 150 is 0 and a tilt angle on the optical axis of the object-side surface 162 of the sixth lens 160 is 0, the maximum tilt angle on the object-side surface 162 of the sixth lens 160 may be more 2 times or more, and preferably 2.5 times or more to a point having the vertical distance between the optical axis and the critical point of the object-side surface 152 of the fifth lens 150. For example, the tilt angle on the object-side surface 162 of the sixth lens 160 may have a range of 0 to 35 degrees and the tilt angle on the image-side surface 154 of the fifth lens 150 may have a range of 0 to 17.5 degrees to a point having the vertical distance between the optical axis and the critical point of the object-side surface 152 of the fifth lens 150. When the image-side surface 154 of the fifth lens 150 and the object-side surface 162 of the sixth lens 160 have the tilt angles, light refracted through the object-side surface 142 and the image-side surface 144 of the fourth lens 140 and the object-side surface 152 of the fifth lens 150 may be uniformly dispersed on the image-side surface 154 of the fifth lens 150 and the object-side surface 162 of the sixth lens 160. In this case, the maximum tilt angle may be 65 degrees or less within a range of 60 to 90% of the effective diameter of the image-side surface 164 of the sixth lens 160. Accordingly, manufacturing performance may be improved while satisfying optical performance.

According to the embodiment of the present invention, the image-side surface 154 of the fifth lens 150 is convex toward the image side and the object-side surface 162 of the sixth lens 160 is concave toward the object side, and an absolute value of a radius of curvature of the image-side surface 154 of the fifth lens 150 may be greater than an absolute value of a radius of curvature of the object-side surface 162 of the sixth lens 160. Preferably, the absolute value of the radius of curvature of the image-side surface 154 of the fifth lens 150 may be 2 times or more the absolute value of the radius of curvature of the object-side surface 162 of the sixth lens 160. More preferably, the absolute value of the radius of curvature of the image-side surface 154 of the fifth lens 150 may be 2 to 3 times the absolute value of the radius of curvature of the object-side surface 162 of the sixth lens 160.

When the image-side surface 154 of the fifth lens 150 and the object-side surface 162 of the sixth lens 160 are designed to satisfy the above conditions, light incident on the fifth lens 150 may be dispersed through the fifth lens 150 and the sixth lens 160, and the amount of light which reaches the periphery of the image sensor 180 may be increased.

The optical system 100 according to the embodiment of the present invention may satisfy at least one of the conditional equations described below. Accordingly, the optical system 100 according to the embodiment of the present invention may have an optically enhanced effect. Specifically, the optical system 100 according to the embodiment of the present invention may acquire optical performance in which an effective focal length (EFL) is 3.5950 mm, the F number is 2 or less, the FOV in the diagonal direction is 84 degrees or more, and the RI is 25% or more in the 1 field under the condition that a half value of a diagonal length of a pixel region of the image sensor 180 (H_{imageD}) iS 3.2690 mm.

0.9≤ED_{L1S1}/EPD≤1.1 [Equation 1]

Here, ED_{L1S1} is the effective diameter of the object-side surface 112 of the first lens 110, and an entrance pupil diameter (EPD) is a diameter of an entrance pupil. Accordingly, since the area of the object-side surface 112 of the first lens 110 exposed to the outside may be minimized, the head size of the optical system 100 may be minimized. In addition, light may also be incident on the edge of the object-side surface 112 of the first lens 110. The entire first lens 110 may be the effective region. Preferably, ED_{L1S1}/EPD may be 1 or more and 1.1 or less.

ED_{L1S1}<2H_{imageD} [Equation 2]

Here, H_{imageD} is a half value of the diagonal length of the pixel region of the image sensor 180. Accordingly, since an area where the object-side surface 112 of the first lens 110 is exposed to the outside may be minimized, the head size of the optical system 100 may be minimized.

1.62 mm≤ED_{L1S1}≤1.98 mm [Equation 3]

Accordingly, the head size of the optical system 100 may be minimized.

1.62 mm≤EPD≤1.98 mm [Equation 4]

Accordingly, the head size of the optical system 100 may be minimized.

2≤CT5/CT4 [Equation 5]

Here, CT5 is a center thickness of the fifth lens 150, and CT4 is a center thickness of the fourth lens 140. Accordingly, the assembly and alignment of the optical system are easy.

T23<T12<T45<T34<T56 [Equation 6]

Here, T23 is a distance between the second lens 120 and the third lens 130, T12 is a distance between the first lens 110 and the second lens 120, T45 is a distance between the fourth lens 140 and the fifth lens 150, T34 is a distance between the third lens 130 and the fourth lens 140, and T56 is a distance between the fifth lens 150 and the sixth lens 160. Accordingly, the assembly and alignment of the optical system are easy, light may be collected without distortion through the first lens group G1 even when the effective diameter of the object-side surface 112 of the first lens 110 is sufficiently small, and the light collected by the first lens group G1 may pass through the second lens group G2 and uniformly reach each pixel of the image sensor 180 without distortion.

1.6≤T56/T12≤2.6 [Equation 7]

Accordingly, the assembly and alignment of the optical system are easy, light may be collected without distortion through the first lens group G1 even when the effective diameter of the object-side surface 112 of the first lens 110 is sufficiently small, and the light collected by the first lens group G1 may pass through the second lens group G2 and uniformly reach each pixel of the image sensor 180 without distortion. Preferably, T56/T12 may be 1.9 or more and 2.3 or less.

8≤T56/T23≤12 [Equation 8]

Accordingly, the assembly and alignment of the optical system are easy, light may be collected without distortion through the first lens group G1 even when the effective diameter of the object-side surface 112 of the first lens 110 is sufficiently small, and the light collected by the first lens group G1 may pass through the second lens group G2 and uniformly reach each pixel of the image sensor 180 without distortion. Preferably, T56/T23 may be 9 or more and II or less.

1.5≤T56/T34≤2.5 [Equation 9]

Accordingly, the assembly and alignment of the optical system are easy, and light incident on the second lens group G2 may pass through the second lens group G2 and uniformly reach each pixel of the image sensor 180 without distortion. Preferably, T56/T34 may be 1.6 or more and 2 or less.

1.5≤T56/T45≤2.5 [Equation10]

Accordingly, the assembly and alignment of the optical system are easy, and light incident on the second lens group G2 may pass through the second lens group G2 and uniformly reach each pixel of the image sensor 180 without distortion. Preferably, T56/T45 may be 1.6 or more and 2 or less.

2≤|P1|/|P2| [Equation 11]

Accordingly, the first lens 110 collects the light incident on the optical system 100, and the second lens 120 may correct chromatic aberration.

1.5≤CT1/CT2 [Equation 12]

Accordingly, the first lens 110 collects the light incident on the optical system 100, and the second lens 120 may correct chromatic aberration.

4 mm≤TTL≤4.5 mm [Equation 13]

Here, TTL is a distance from the object-side surface 112 of the first lens 110 to the image sensor 180. When the TTL is smaller than 4 mm, manufacturability is poor and it may be difficult to achieve a preferable effective focal length, and when the TTL exceeds 4.5 mm, the size of the camera device increases and thus it may be difficult to implement the camera device in a compact size in a mobile terminal.

0.6 mm≤BFL [Equation 14]

Here, BFL is a distance from the image-side surface 164 of the sixth lens 160 to the image sensor 180. Accordingly, the assembly of the optical system may be enhanced.

1.11≤TTL/EFL≤1.26 [Equation15]

Here, EFL is an effective focal length. Accordingly, a high-resolution image may be acquired even in a narrow space.

1.22≤TTL/H_{imageD}≤1.38 [Equation 16]

Accordingly, a high-resolution image may be acquired even in a narrow space.

2.2≤TTL/EPD≤2.5 [Equation 17]

Accordingly, the head size of the optical system 100 and the overall size of the camera device may be miniaturized.

ED_{G1_max}<EDG2_min [Equation 18]

Here, ED_{G1_max} is the maximum effective diameter in the first lens group and ED_{G2_min} is the minimum effective diameter in the second lens group. Accordingly, the first lens group G1 may serve to collect the light incident on the optical system 100 to adjust an incident angle of light incident on the second lens group G2. Further, the second lens group G2 may serve to disperse the light incident on the second lens group G2 after passing through the first lens group G1 to increase an amount of light which reaches the periphery of the image sensor 180.

ED_{L4S1}<ED_{L4S2}<ED_{L5S1},<ED_{L5S2}<ED_{L6S1}<ED_{L6S2}[Equation19]

Here, ED_{L4S2} is an effective diameter of the object-side surface 142 of the fourth lens 140, ED_{L4S2} is an effective diameter of the image-side surface 144 of the fourth lens 140, ED_{L5S1} is an effective diameter of the object-side surface 152 of the fifth lens 150, ED_{L5S2} is an effective diameter of the image-side surface 154 of the fifth lens 150, ED_{L6S1} is an effective diameter of the object-side surface 162 of the sixth lens 160, and ED_{L6S2} is an effective diameter of the image-side surface 164 of the sixth lens 160. Accordingly, the second lens group G2 may serve to disperse the light incident on the second lens group G2 after passing through the first lens group G1 to increase an amount of light which reaches the periphery of the image sensor 180.

ED_{G1_max}/ED_{L6S2}≤0.7 [Equation 20]

Accordingly, the first lens group G1 may serve to collect the light incident on the optical system 100 to adjust an incident angle of light incident on the second lens group G2. Further, the second lens group G2 may serve to disperse the light incident on the second lens group G2 after passing through the first lens group G1 to increase an amount of light which reaches the periphery of the image sensor 180. Preferably, ED_{G1_max}/ED_{L6S2} may be 0.6 or less.

T12ₘₐₓ/T12ₘᵢₙ≤3 [Equation 21]

Here, T12ₘₐₓ is a maximum distance between the image-side surface 114 of the first lens 110 and the object-side surface 122 of the second lens 120, and T12ₘᵢₙ is a minimum distance between the image-side surface 114 of the first lens 110 and the object-side surface 122 of the second lens 120. Accordingly, light may reach from the image-side surface 114 of the first lens 110 to the object-side surface 122 of the second lens 120 without spreading.

T23ₘₐₓ/T23ₘᵢₙ≤3 [Equation 22]

Here, T23ₘₐₓ is a maximum distance between the image-side surface 124 of the second lens 120 and the object-side surface 132 of the third lens 130, and T23ₘᵢₙ is a minimum distance between the image-side surface 124 of the second lens 120 and the object-side surface 132 of the third lens 130. Accordingly, light may reach the object-side surface 132 of the third lens 130 from the image-side surface 124 of the second lens 120 without spreading.

T34ₘₐₓ/T34ₘᵢₙ≤3 [Equation 23]

Here, T34ₘₐₓ is a maximum distance between the image-side surface 134 of the third lens 130 and the object-side surface 142 of the fourth lens 140, and T34ₘᵢₙ is a minimum distance between the image-side surface 134 of the third lens 130 and the object-side surface 142 of the fourth lens 140. Accordingly, light may reach the object-side surface 142 of the fourth lens 140 from the image-side surface 134 of the third lens 130 without spreading. Preferably, T34ₘₐₓ/T34ₘᵢₙ may be 2 or less.

0.9≤T_CP_{L4S1}/T_CP_{L4s2}≤1.1 [Equation 24]

Here, T_CP_{L4S1} is the distance from the optical axis to the critical point of the object-side surface 142 of the fourth lens 140, and T_CP_{L4S2} is the distance from the optical axis to the critical point of the image-side surface 144 of the fourth lens 140. Accordingly, the second lens group G2 may serve to disperse the light incident on the second lens group G2 after passing through the first lens group G1 to increase the amount of light which reaches the periphery of the image sensor 180. Further, since the light effectively refracted at the critical point of the object-side surface 142 of the fourth lens 140 is effectively refracted again at the critical point of the image-side surface 144 of the fourth lens 140, an effective refraction effect of the light may be maximized. Preferably, T_CP_{L4s1}/T_CP_{L4S2} may be 0.95 or more and 1.05 or less.

0.9≤T_CP_{L4S1}/T_CP_{L4S1}≤1.1 [Equation 25]

Here. T_CP_{L5S1} is the distance from the optical axis to the critical point of the object-side surface 152 of the fifth lens 150. Accordingly, the second lens group G2 may serve to refract and disperse the light incident on the second lens group G2 after passing through the first lens group G1 to increase the amount of light which reaches the periphery of the image sensor 180. Further, since the light effectively refracted at the critical point of the object-side surface 142 of the fourth lens 140 is effectively refracted again at the critical point of the object-side surface 152 of the fifth lens 150, an effective refraction effect of the light may be maximized. Preferably, T_CP_{L4S1}/T_CP_{L5S1} may be 0.95 or more and 1.05 or less.

T45ₘₐₓ/T45ₘᵢₙ≤3 [Equation 26]

Here, T45ₘₐₓ is a maximum distance between the image-side surface 144 of the fourth lens 140 and the object-side surface 152 of the fifth lens 150, and T45ₘᵢₙ is a minimum distance between the image-side surface 144 of the fourth lens 140 and the object-side surface 152 of the fifth lens 150. Accordingly, the assembly and alignment of the optical system are easy.

3<T56ₘₐₓ/T56 min [Equation 27]

Here, T56ₘₐₓ is a maximum distance between the image-side surface 154 of the fifth lens 150 and the object-side surface 162 of the sixth lens 160, and T56ₘᵢₙ is a minimum distance between the image-side surface 154 of the fifth lens 150 and the object-side surface 162 of the sixth lens 160. Accordingly, the light incident on the fifth lens 150 may be dispersed through the fifth lens 150 and the sixth lens 160, and the amount of light which reaches the periphery of the image sensor 180 may be increased. Preferably, T56ₘₐₓ/T56ₘᵢₙ may exceed 4.

SA_{L5S2_max}<SA_{L6S1_max} [Equation 28]

Here, SA_{L5S2_max} may be a maximum tilt angle of the image-side surface 154 of the fifth lens 150, and SA_{L6s1_max} may be a maximum tilt angle of the object-side surface 162 of the sixth lens 160. This condition may be satisfied in a region where a vertical distance from the optical axis is within T_CP_{L1S1}, T_CP_{L4S2}, or T_CP_{L5S1}. Accordingly, the light incident on the fifth lens 150 may be dispersed through the fifth lens 150 and the sixth lens 160, the amount of light which reaches the periphery of the image sensor 180 may be increased, and manufacturing performance may be improved while satisfying optical performance.

2≤SA_{L6S1_max}/SA_{L5S2_max} [Equation 29]

Here, this condition may be satisfied in a region where a vertical distance from the optical axis is within T_CP_{L4S1}, T_CP_{L4S2}, or T_CP_{L5S1}. Accordingly, the light incident on the fifth lens 150 may be dispersed through the fifth lens 150 and the sixth lens 160, the amount of light which reaches the periphery of the image sensor 180 may be increased, and manufacturing performance may be improved while satisfying optical performance.

0 degrees≤SA_{L6S1}≤35 degrees [Equation 30]

Here, SA_{L6S1} is a tilt angle of the object-side surface 162 of the sixth lens 160, and this condition may be satisfied in a region where a vertical distance from the optical axis is within T_CP_{L4S1}, T_CP_{L4S2}, or T_CP_{L5S1}. Accordingly, the light incident on the fifth lens 150 may be dispersed through the fifth lens 150 and the sixth lens 160, the amount of light which reaches the periphery of the image sensor 180 may be increased, and manufacturing performance may be improved while satisfying optical performance.

0 degrees≤SA_{L5S2}≤17.5 degrees [Equation 31]

Here, SA_{L5S2} is a tilt angle of the image-side surface 154 of the fifth lens 150, and this condition may be satisfied in a region where a vertical distance from the optical axis is within T_CP_{L4S1}, T_CP_{L4S2}, or T_CP_{L5S1}. Accordingly, the light incident on the fifth lens 150 may be dispersed through the fifth lens 150 and the sixth lens 160, the amount of the light which reaches the periphery of the image sensor 180 may be increased, and manufacturing performance may be improved while satisfying optical performance.

|R_{L6S1}|≤|R_{L5S2}| [Equation 32]

Here, R_{L6S1} is the radius of curvature of the object-side surface 162 of the sixth lens 160, and R_{L5S2} is the radius of curvature of the image-side surface 154 of the fifth lens 150. Accordingly, the light incident on the fifth lens 150 may be efficiently dispersed through the fifth lens 150 and the sixth lens 160.

2≤|R_{L5S2}|/|R_{L6S1}| [Equation 33]

Accordingly, the light incident on the fifth lens 150 may be efficiently dispersed through the fifth lens 150 and the sixth lens 160.

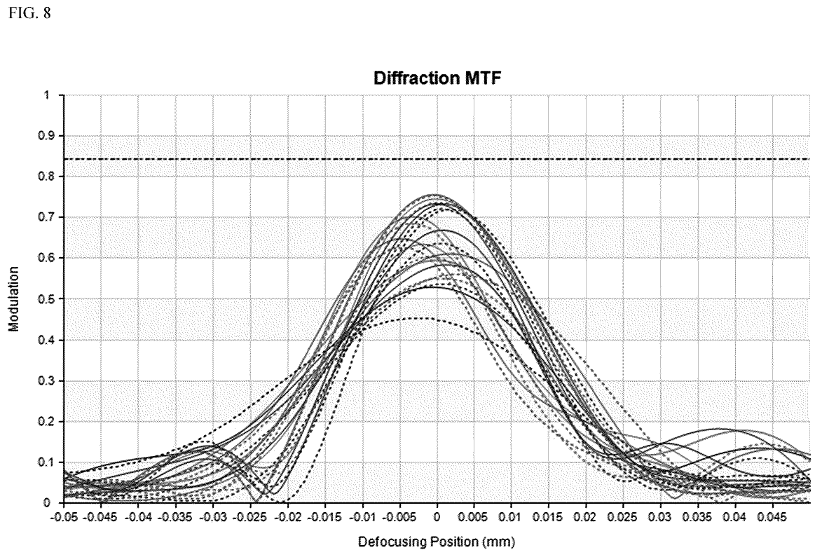

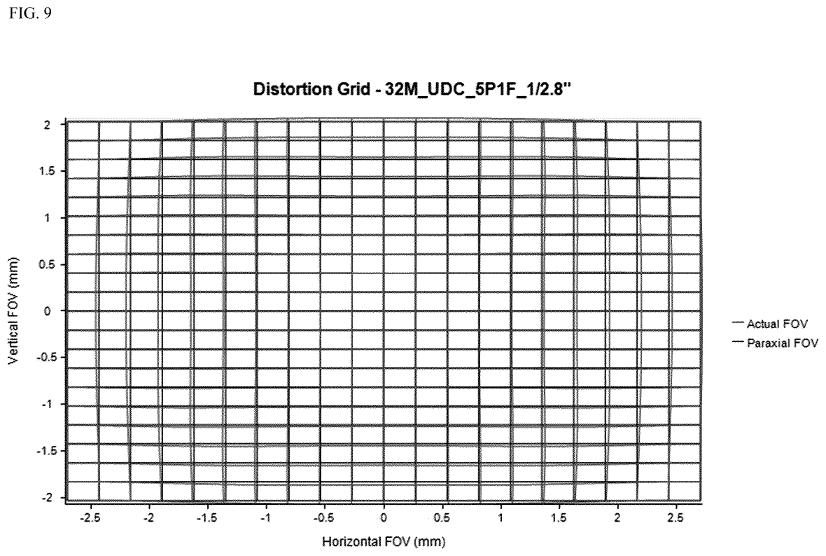

Table 5 shows chief ray angle (CRA) data and RI values which may be acquired using the optical system according to the embodiment of the present invention, by field, FIG. 8 shows a modulation transfer function (MTF) using the optical system according to one embodiment of the present invention, and FIG. 9 shows a distortion grid using the optical system according to one embodiment of the present invention.

TABLE 5

| Field | CRA | RI (%) |
|---|---|---|
| 0 | 8.20295 | 100.0% |
| 0.1 | 15.9567 | 97.9% |
| 0.2 | 22.8603 | 92.1% |
| 0.3 | 28.6354 | 84.1% |
| 0.4 | 33.1184 | 74.7% |
| 0.5 | 36.0282 | 65.0% |
| 0.6 | 36.9021 | 56.7% |
| 0.7 | 36.4433 | 50.7% |
| 0.8 | 36.4077 | 43.1% |
| 0.9 | 36.9158 | 34.2% |
| 1 | 8.20295 | 26.3% |

Referring to Table 5, in the optical system according to the embodiment of the present invention, it can be seen that an amount of light at the periphery of the image sensor (1 field) is 25% or more when a chief ray angle (CRA) is 8 degrees or more, for example, a range of 8 degrees to 37 degrees, and an amount of light at a central portion of the image sensor (0 field) is 100%. Referring to FIG. 8, the sharpness of an image in a spatial frequency according to a pixel which may be acquired from the optical system according to one embodiment of the present invention may be acquired, and referring to FIG. 9, the degree of distortion of the image which may be acquired from the optical system according to one embodiment of the present invention may be acquired.

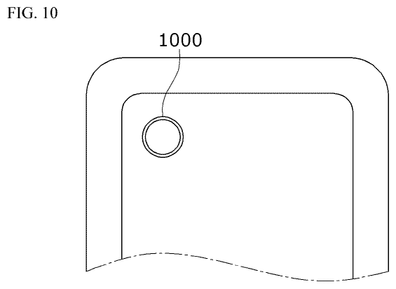

FIG. 10 is a view showing a portion of a mobile terminal to which a camera device according to one embodiment of the present invention is applied.

Meanwhile, the optical system 100 according to the embodiment of the present invention may be applied to a camera device 1000. The camera device 1000 including the optical system 100 according to the embodiment of the present invention may be built in a mobile terminal and applied along with a main camera module. The camera device 1000 according to the embodiment of the present invention may include an image sensor, a filter disposed on the image sensor, and an optical system 100 disposed on the filter, and the optical system 100 according to the embodiment of the present invention may include the above-described first lens 110, second lens 120, third lens 130, fourth lens 140, and fifth lens 150. The mobile terminal with a built-in camera device including the optical system according to the embodiment of the present invention may be a smartphone, a tablet personal computer (PC), a laptop computer, a personal digital assistant (PDA), or the like.

The optical system 100 according to the embodiment of the present invention may be disposed at the front or rear side of the mobile terminal, or may be disposed under a display of the mobile terminal.

The optical system 100 according to the embodiment of the present invention may be sequentially disposed in a lateral direction of the mobile terminal due to a thickness constraint of the mobile terminal. To this end, as described above, a right-angled prism may be further disposed on a front end of the first lens 110.

The mobile terminal may be a smartphone, a tablet PC, a laptop computer, a PDA, or the like.

Although the embodiments have been mainly described above, these are merely examples and are not intended to limit the present invention, and it can be seen that various modifications and applications not exemplified herein are possible without departing from the essential characteristics of the present invention by those skilled in the art. For example, each of the components specifically shown in the embodiments may be modified and implemented. Further, it should be interpreted that differences related to the modifications and the applications are included in the scope of the present invention defined by the appended claims.

### REFERENCE NUMERALS

100: optical system
110: first lens
120: second lens
130: third lens
140: fourth lens
150: fifth lens
160: sixth lens
170: filter
180: image sensor

1.-10. (canceled)

11. An optical system comprising a first lens, a second lens, a third lens, a fourth lens, a fifth lens, and a sixth lens which are sequentially disposed from an object side to an image side,
wherein the first lens has positive refractive power, the second lens has negative refractive power, the third lens has positive refractive power, the fourth lens has negative refractive power, the fifth lens has positive refractive power, and the sixth lens has negative refractive power,
wherein a diameter of the first lens is 90 to 110% of an entrance pupil diameter (EPD),
wherein an image-side surface of the fifth lens is convex toward the image side,
wherein an object-side surface of the sixth lens is concave toward the object side, and
wherein a maximum tilt angle on the object-side surface of the sixth lens is larger than a maximum tilt angle on the image-side surface of the fifth lens from the optical axis to a certain distance.

12. The optical system of claim 11, wherein an aperture is disposed at an edge of an object-side surface of the first lens.

13. The optical system of claim 11, wherein a distance between the image-side surface of the fifth lens and the object-side surface of the sixth lens decreases as it gets farther away from the optical axis to a certain distance from the optical axis.

14. The optical system of claim 11, wherein a ratio of an absolute value of a radius of curvature of the object-side surface of the sixth lens to an absolute value of a radius of curvature of the image-side surface of the fifth lens is 2 to 3.

15. The optical system of claim 11, wherein at least one of an object-side surface of the second lens, an image-side surface of the third lens, an object-side surface of the fourth lens, an image-side surface of the fourth lens, an object-side surface of the fifth lens, and an image-side surface of the sixth lens includes a critical point.

16. The optical system of claim 15, wherein a vertical distance from the optical axis to the critical point of the object-side surface of the fourth lens is 0.9 to 1.1 times a vertical distance from the optical axis to the critical point of the image-side surface of the fourth lens, and is 0.9 to 1.1 times a vertical distance from the optical axis to the critical point of the object-side surface of the fifth lens.

17. The optical system of claim 16, wherein the certain distance is a vertical distance between at least one of the critical point of the object-side surface of the fourth lens, the critical point of the image-side surface of the fourth lens, and the critical point of the object-side surface of the fifth lens and the optical axis.

18. The optical system of claim 11, wherein an F-number is 2 or less, a field of view (FOV) is 84 degrees or more, and a relative illumination (RI) is 25% or more.

19. The optical system of claim 11, wherein the first lens has the smallest diameter among the first to sixth lenses, and
wherein an object-side surface of the fourth lens, an image-side surface of the fourth lens, and an object-side surface of the fifth lens each includes a critical point.

20. The optical system of claim 19, wherein an absolute value of a radius of curvature of the image-side surface of the fifth lens is greater than an absolute value of a radius of curvature of the object-side surface of the sixth lens.

21. The optical system of claim 17, wherein a maximum tilt angle on the object-side surface of the sixth lens is larger than a maximum tilt angle on the image-side surface of the fifth lens to a vertical distance between at least one of the critical point of the object-side surface of the fourth lens, the critical point of the image-side surface of the fourth lens, and the critical point of the object-side surface of the fifth lens and the optical axes.

22. The optical system of claim 11, wherein the second lens or the fourth lens has the smallest center thickness among the first to sixth lenses, and the fifth lens has the largest center thickness among the first to six lenses.

23. The optical system of claim 11, wherein the first lens, the second lens, and the third lens have positive composite power, and the fourth lens, the fifth lens, and the sixth lens have negative composite power.

24. The optical system of claim 11, wherein an absolute value of power of the first lens is 2 times or more an absolute value of power of the second lens, and a center thickness of the first lens is 1.5 times or more a center thickness of the second lens.

25. The optical system of claim 15, wherein the image-side surface of the third lens includes the critical point.

26. The optical system of claim 15, wherein at least three of six surfaces of the fourth lens, the fifth lens, and the sixth lens include critical points.

27. The optical system of claim 15, wherein the image-side surface of the fifth lens and the object-side surface of the sixth lens do not include a critical point.

28. A camera device comprising:
an image sensor;
a filter disposed on the image sensor; and
an optical system disposed on the filter,
wherein the optical system includes a first lens, a second lens, a third lens, a fourth lens, a fifth lens, and a sixth lens which are sequentially disposed from an object side to an image side,
wherein the first lens has positive refractive power, the second lens has negative refractive power, the third lens has positive refractive power, the fourth lens has negative refractive power, the fifth lens has positive refractive power, and the sixth lens has negative refractive power,
wherein a diameter of the first lens is 90 to 110% of an entrance pupil diameter (EPD),
wherein an image-side surface of the fifth lens is convex toward the image side,
wherein an object-side surface of the sixth lens is concave toward the object side, and
wherein a maximum tilt angle on the object-side surface of the sixth lens is larger than a maximum tilt angle on the image-side surface of the fifth lens from the optical axis to a certain distance.

29. The camera device of claim 28, wherein an aperture is disposed at an edge of an object-side surface of the first lens.

30. The camera device of claim 28, wherein a distance between the image-side surface of the fifth lens and the object-side surface of the sixth lens decreases as it gets farther away from the optical axis to a certain distance from the optical axis.
